(19) United States
(12) Patent Application Publication
(10) Pub. No.: US 2026/0141335 A1
(43) Pub. Date: May 21, 2026

(54) System and Method of Arrangement and Management of the Flow for a Golf Course

(71) Applicant: Jeffrey Ash, Mountain Lakes, NJ (US)

(72) Inventor: Jeffrey Ash, Mountain Lakes, NJ (US)

(21) Appl. No.: 18/951,407

(22) Filed: Nov. 18, 2024

(51) Int. Cl. G06Q 10/08; A63B 71/06; A63B 102/32

(52) U.S. Cl. CPC G06Q 10/08; A63B 71/0622; A63B 2102/32

(57) ABSTRACT

A method of arranging a golf course to enable improved flow management of users through the course. A method and system for efficiently facilitating rounds of play on a golf course whose layout is designed according to the preceding arrangement method. The invention serves to efficiently route individuals and/or groups through the course while minimizing participant idleness and resource overlap. The course arrangement provides for alternate routes which allow participants to experience the entirety of a course while avoiding participants enjoying the course at a different pace. The logistical management provides tailored directions to participants by evaluating the rate and positions of players to determine optimal pathing.

### FIELD OF THE INVENTION

The present invention relates generally to logistics in a series of connected activities. Specifically, the invention is a method that allows for efficiently moving groups through a round of golf and similarly arranged events.

### BACKGROUND OF THE INVENTION

Golf is a revered pastime in several parts of the world. The sport itself has been refined and perfected over a few hundred years. Notably, the technology used in sports has grown dramatically over the last four decades, with golf as no exception. This has resulted in improved individual performance through applied kinesiology and exceptional equipment using precision manufacturing techniques. All said, golf and other sports have transformed fantastically during this period.

Outside of sporting performance, technology has also aided in making games more approachable or easier to facilitate. Technology has been developed which can be used to quickly and accurately perform a lot of administrative tasks for games. Managing scores for more complex scoring systems, such as those used in bowling or cricket, is a triviality with computerized scoring. Video technology allows for replayed recordings to be used in aiding the adjudication of events where the referee or judge may have missed important details. It is clear that technology is being increasingly integrated into the fabric of our sporting activities.

Considering the role of technology in improving how we enjoy sports and leisure, it becomes quite noticeable where technology seems absent, particularly in those experiences where certain mundane or overhead factors muddle our enjoyment. Golf is particularly susceptible to some of these situations. When on a golf outing, your group may play faster or slower than another group playing the same course. This will result in one group waiting to play their next hole as the group in front finishes, sometimes creating a significant delay and idle period for the second group. Etiquette often calls for the faster group's allowance to play-through (play the hole before the slower group, despite the slower group arriving first). However, this solution merely shifts the idle state from one group to another. The present invention aims to address this shortcoming.

The present invention is a system of nodal arrangement and logistical management for multiple groups to progress through a uniquely assigned course. Primarily, the method begins with arranging the course in a particular manner. By positioning clusters of holes around several nodes, we can route participants to one of several holes as they reach a node. This enables participants to be routed to clear locations, reducing the necessity of waiting while avoiding significant additional walking and extensive backtracking that may have occurred if participants were to temporarily skip holes. While participants may play holes with this invention in what would be considered out of order on a traditional course, they would still experience the entirety of what the course offers. This element is also facilitated by the hole numbers being dynamically updated in how they are displayed to participants, precluding them from knowing they are playing any holes in or out of any typical order.

A second major aspect of the method is the use of duplicate holes. These holes would either be functionally identical to a given hole (in terms of distance, strokes, and other relevant qualities) or a mirror image of that hole. These holes serve as additional flow-routing options, allowing participants to be routed to play either hole in substitution for the other. This aspect allows the course to provide an equivalent experience over multiple routes and further improves its ability to usher multiple concurrent groups of players through the series. Using these mirror image holes, we offer a standardization of play that can be used to compare groups by calculating and estimate anticipated playing times for future holes. This allows us to separate groups progressing at different rates.

For facilitating the hole assignments, an underlying software system can utilize the timing data acquired through any groups'traversal of the early duplicate holes (whether mirrored or identical) to estimate the expected rate at which each group will move through the course and update this as the group progresses through the course. This estimation allows a system to dynamically select and assign holes to groups on the course utilizing comparative time expectations for each participant at each assigned position. Even the duplicate holes will have crossover connections to what may appear to be the opposite member of the subsequent duplicate set, allowing faster playing groups to be reassigned and rerouted even at the more linear arrangements of the course's early and end stages. This is particularly helpful toward the end of the course, as the later holes might otherwise become a chokepoint when many groups may be approaching a given hole from a variety of potential prior holes.

In total, the invention provides an optimizable method for managing the flow of players through a golf course. By utilizing the designated arrangement, the management aspects of the method are enabled to reduce the drag on both course throughput and player enjoyment associated with the time wasted in waiting. The method will generally be implemented through a software management application, allowing for efficient and real-time routing management that would otherwise be cumbersome and otherwise inefficient.

While the present invention is primarily a solution directed towards golf course flow management, including miniature golf, it is applicable to a number of foreseeable activities. For example, a museum or site-seeing tour where one would like to control the amount of visitors present at each given exhibit without strictly controlling the schedule or timing of individual tour groups would potentially be able to employ this method.

### BRIEF DESCRIPTION OF THE DRAWINGS

FIG. 1a is a routing diagram for an embodiment of the present invention, demonstrating the potential route for an 18 zone circuit.

FIG. 1b is a routing diagram for an embodiment of the present invention, demonstrating the potential routes for a 9 zone circuit implemented on a layout implemented for 9 or 18 zone circuits.

FIG. 2 is a flow diagram for an embodiment of the present invention, demonstrating the method steps.

### DETAIL DESCRIPTIONS OF THE INVENTION

All illustrations of the drawings are for the purpose of describing selected versions of the present invention and are not intended to limit the scope of the present invention.

The present invention is directed towards the arrangement and management of a golf course. However, a person of ordinary skill in the art would recognize applicability to similarly sequenced experiences such as museum tours, stations in an exercise circuit for a team, or a series of presentations at an exposition. Essentially, any series of activities where access space is limited may apply the method of the present invention if certain aspects can be, approximately, duplicated or otherwise analogous experiences presented as alternative groups. As such, the term zone is used throughout the description as a generalization of holes in a golf course or a similar area of activity. For example, the referenced series of zones (or circuit) would be the equivalent to a “round” of golf or similar event, whether that be nine or eighteen holes. Additional zones could be offered as needed.

The method of the present invention requires a managed arrangement for a series of zones (circuit), a map of potential zone routes, and a software application to manage the logistics of guiding multiple concurrent participants through the series. The software is executed by a server and communicates through a server interface and a number of participant interfaces over a network, typically wirelessly. An alternate embodiment would provide for participant interfaces to be assigned to each zone where participants would interface with the device as they interact with the zone. This alternate embodiment would also allow for wired network connections, as well as wireless connections. The participant interfaces are used to identify and track groups through the circuit. Some embodiments may allow participants to actively interact with the application, accessing additional services such as scoring and communicating additional information, including ordering the participant group's turn order based on a previous hole's score.

The zonal arrangement elements of the method require that zones be divided into several types of groups. A first group of zones would be designated as starting zones. An arrangement comprising two starting zones is the preferred embodiment, while arrangements with additional starting zones are conceivable alternate embodiments. The starting zones would connect to a series of similarly grouped zones, designated as ventral units. Each ventral unit would comprise a number of ventral zones corresponding to the number of starting zones (i.e., two ventral zones per ventral unit when there are two starting zones). The ventral units would be a sequenced series, where a participant group is guided to a single zone of each ventral unit as it is routed through the overall circuit. The zones in the first ventral unit would have a one-to-one ingress connection with its corresponding starting zone and a one-to-many egress connection to each zone of the next subsequent ventral unit. Likewise, each zone of the subsequent ventral units would similarly have a one-to-many egress connection with each zone of the next subsequent ventral unit (resulting in a one-to-many ingress connection at zones of the second and later ventral units). The zones in the final ventral unit would, instead, have a one-to-many egress connection with zero or more spoke zones and the central access area of a first zonal hub. The preferred embodiment would comprise of a connection to the first spoke zone of the first zonal hub.

Zonal hubs comprise of a central access area and two or more spoke zones. The spoke zones are connected to and arranged radially around the central access area. The spoke zones may be connected to the zones of a ventral or retral unit and may be connected to either of the potentially adjacent spoke zones in the radial arrangement of the zonal hub. Typically, a zonal hub will comprise as many as six spoke zones. Some embodiments may allow for more spoke zones. The preferred embodiment would utilize an even number of spoke zones at each hub, such that each spoke zone may be paired with another. This pairing allows for arrangements where the first spoke of the pair has a natural direction away from the hub and the second zone of the pair has a natural direction back towards the hub, making traversal more efficient.

Spoke zones may be referenced as a sequence, either numerically or for specifying the first and last spokes. In some embodiments, spoke zones may also have a connection to one or more spoke zones or central access areas in one or more other zonal hubs. One or more spoke zones will comprise a one-to-many egress connection to the zones of a first retral unit. A participant group will typically be guided through each spoke zone of each zonal hub when being guided through a complete circuit. However, when a participant group only elects to experience an abbreviated circuit, they may be guided through fewer spokes.

The retral units are groups of retral zones leading toward the end of the circuit. Typically, these retral groups will also correspond to the number of starting and ventral zones in their appropriate groups. The retral units would be a sequenced series, where a participant group is guided to a single zone of each retral unit as it is routed through the overall circuit. Each zone of the subsequent retral units would have a one-to-many egress connection with each zone of the next subsequent retral unit. The zones in the final retral unit would have egress connections with each zone of the terminal unit. The terminal unit demarcates the group of zones designated as the final activity of the circuit. Embodiments with multiple terminal zones are considered, though a single terminal zone is generally preferred to provide a single point of culmination for the circuit.

The map of potential zones for a participant group would then necessarily include one starting zone to begin, then one ventral zone at each ventral unit in sequence, then at least two or more spoke zones in any order from a zonal hub, then one retral zone at each retral unit in sequence, and then the terminal zone to conclude the circuit. Larger circuits would include a second zonal hub between the first zonal hub spoke zones and the retral unit zones. The preferred embodiment for combined arrangement of zones and a participant group's progress routing through the arrangement in a full circuit would be one of a pair of starting zones, one zone at each subsequent pair in a series of two ventral units, six spoke zones at a first zonal hub in any order, six spoke zones at a second zonal hub in any order for the first five then the sixth with a connection to the first retral unit, one zone at each subsequent pair in a series of two retral units, and then the terminal zone. Alternate embodiments may allow for egress to the retral zones from the second zonal hub's central access area or a second spoke zone of the zonal hub.

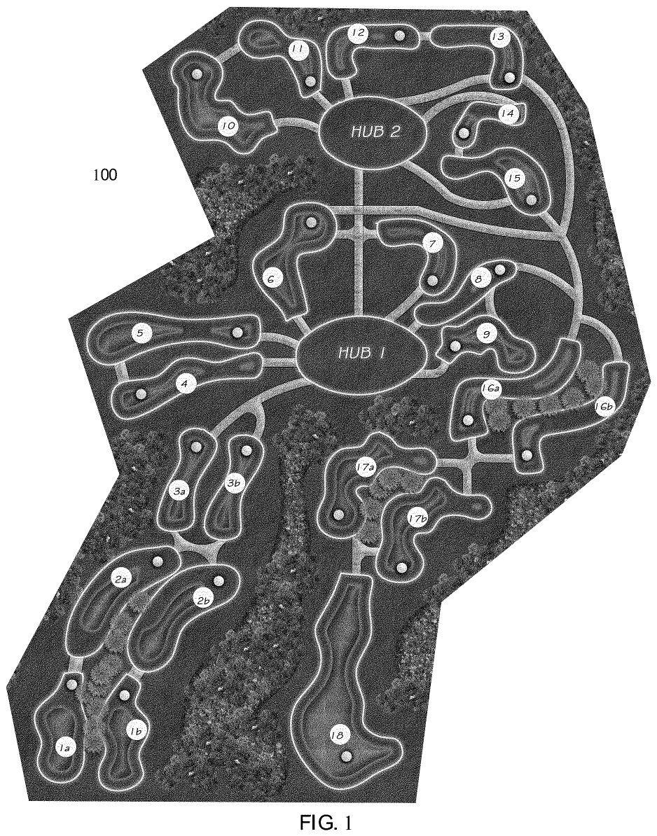

A sample routing diagram for a circuit with 18 potential zones (100) are visualized on FIGS. 1a & 1b. FIG. 1a demonstrates a potential routing through a full circuit of 18 zones. Likewise, FIG. 1b demonstrates a truncated potential route through a 9 zone circuit out of the possible 18 zones. Traversing the circuit with either routing begins with a starting zone (101) which are mirrored, copied, or substantially similar as previously described. A participant individual or group will then be routed through the ventral zones (102) in sequence. These zones are also mirrors or copies of the other zone(s) at the same point in the circuit in order to produce a nearly identical experience for the patrons.

Once the ventral zones (102) have been completed, the participants will be routed through a zonal hub (103) to one or more sets of hub zones (104). For the sample embodiment, participants may be routed to zones in the pairings of 4-5, 6-7, or 8-9 in any sequence on a full circuit. Other embodiments may allow for zones to be unpaired or the routing to be multidirectional. On a 9 zone circuit, the sample embodiment routes participants to one of the pairings of zones 4-5 or 6-7 and then through zone 8 before proceeding. For this routing option, zone 8 represents the sixth zone of the circuit and is visualized through FIG. 1b. Alternate embodiments would also allow for a group that was routed through zones 4-5 to be (optionally) routed through zone 6 before proceeding to the retral zones (105) on the abbreviated circuit. Another embodiment would allow for groups to be (optionally) routed through zone 9 before proceeding to the retral zones (105) on the abbreviated circuit. Other embodiments may allow for proceeding directly to the retral zones (105) or second zonal hub (113) from the zonal hub (103).

For the full circuit, shown in FIG. 1a, participants will then travel to a second zonal hub (113) once completing the zones (104) of the first zonal hub (103). Similar to the previous zonal hub (103), participants may be routed to zones in the pairings of 10-11, 12-13, or 14-15 in any sequence. The sample embodiment would include a preference for assigning the 12-13 or 14-15 pairings as the last of the three in the sequence, because of more direct routes or pathways to the retral zones (105). However, alternate embodiments may allow for any or all hub zones (104 & 114) to be more directly connected with the ventral zones (105). Once the zones (114) around the second hub (113) have been visited, participants will be directed toward the retral zones (105).

Upon reaching the retral zones (105), participants will be directed to one zone for each matched set of zones remaining in the circuit. As an example, the first retral zone (105) will represent the 16th visited zone for a participant on the full circuit while for the truncated circuit it would represent the 7th visited zone. Embodiments may allow for the zone numbers to be displayed as a set identifier or as a subjective identifier, according to the route taken by the participants. Like the ventral zones (102), the retral zones (105) are mirrored, copies of, or substantially similar to the other zones at the same point in the sequence. Once each of the retral zones (105) have been visited in sequence, the participants are directed to the terminal zone (106) representing the end of their circuit upon completion.

The computerized element of the invention requires a server, a network, one or more participant interfaces each assigned to a participant group, one or more sensors at each zone, and a software logistical application. The server comprises a microprocessor, an interface, and non-transitory storage media. The server operates to execute the application, store related data for managing the circuit, and communicate data to participant groups over the network through the participant interfaces. Typical embodiments will realize the participant interfaces as mobile computing devices, which provide an interface allowing some access to the logistical application's information, such as directions toward the next zone. Additional interfaces may be provided to provide stored session and logistical information, such as digital displays affixed within a zone's area which show the participant(s)' scores, directions to locate subsequent zones, the ordering of individual participants within a group, and other desired information. In some embodiments, the interface may take the form of a digital screen or sign at each given zone which provides relevant information. Further embodiments may incorporate additional features to streamline administration of a group's activities through zones in the circuit, such as scoring, note taking, messaging services, amenities, or advertising.

The application operates by identifying participant groups. It then flags the group and its assigned interface as active, enabling tracking functionality. As a group enters and exits each zone, a time is logged. The logged times are used to determine the group's likely temporal requirements, ranking active groups based on comparative pacing, and updating expectations after each subsequent zone. The application pre-emptively maps potential routes through the circuit for each group, depending on the number of zones in which they indicate they will participate. Using the rankings, current expectations, and positions of active groups, a given group will be assigned a next zone destination from its potential route map after its departure from each zone. Once assigned, the group's interface will receive notification of their subsequent destination until the group completes the circuit.

Alternate embodiments would account for more complex calculations of expected time at each given zone, incorporating stored data of past participants at a given zone. Embodiments may also account for breaks taken by participants. Additional calculations could account and provide weighting for the number of participants in a given group. More complex modeling would allow for more precise predictions of future group positions by comparing expected times at a given zone with the currently active groups'rankings. Such modeling could incorporate elements such as weather tracking and other environmental conditions. Embodiments may also account for changes in pace of groups as they progress.

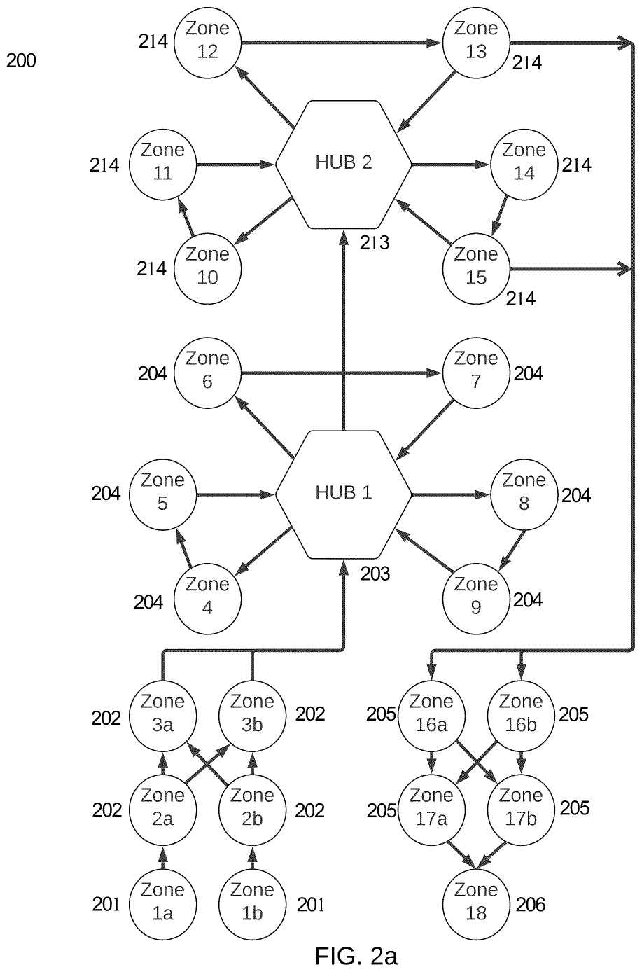

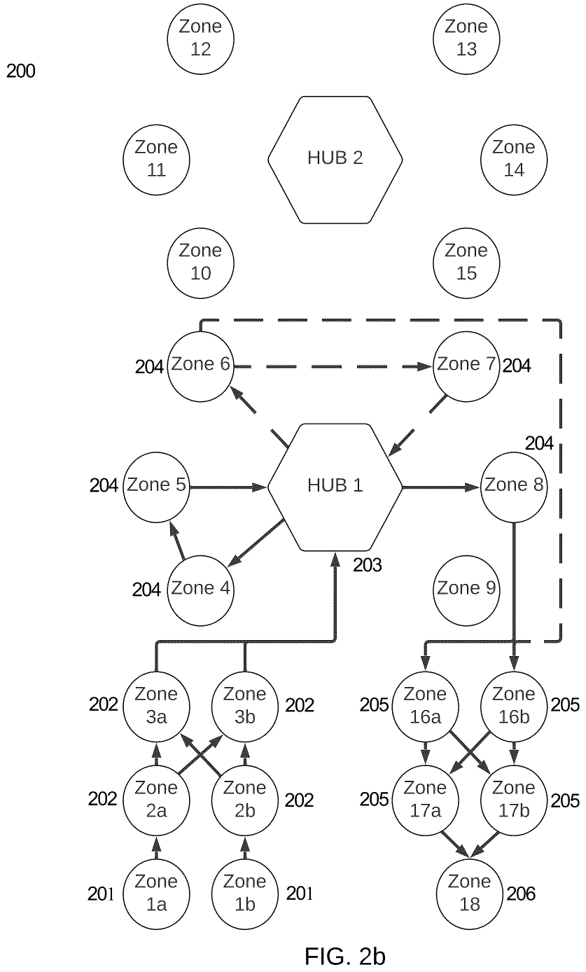

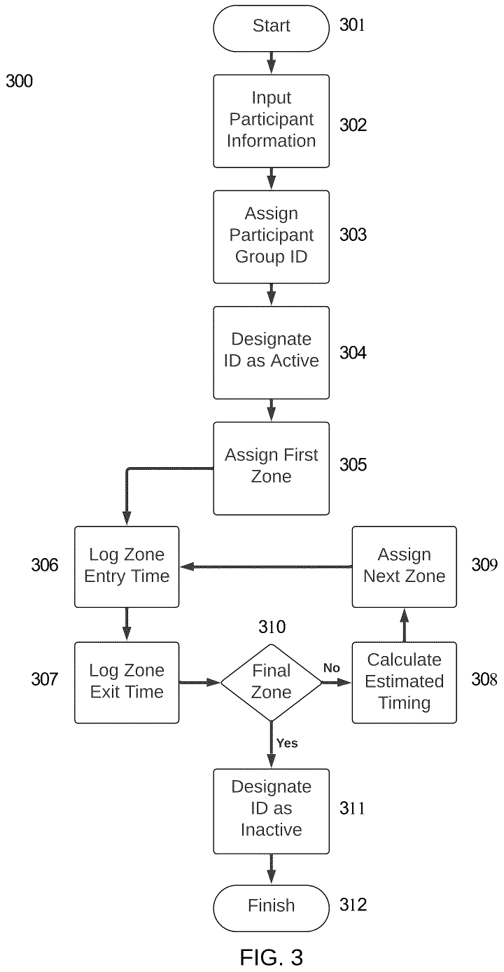

FIG. 2 provides an example embodiment (200) of the present invention's method. When a circuit is initialized (201), participants are directed to provide identifying information (202). This information may include logging into a profile for some embodiments or simply providing names in other embodiments. The system then assigns an identifier (203) by which to track the participant and/or their group. Once assigned, the system designates the participants as active (204) and assigns a starting zone (205). Arrival at the first zone is logged (206) and the participants may experience or perform whatever activity is slated for that zone. Once completed, the system logs the completion time for the zone (207) to be used in any timing calculations. The system then determines if the zone is the final zone in the sequence (210). If the zone is not final, the system determines how much time the participant(s) are likely to need and/or wait as well as what subsequent potential zones are available (208). Upon this determination, the system will assign the next zone (209) and the sequence will loop to the logging point at the assigned zone (206). Once the final zone has been determined (210) the system will designate the assigned ID for the participant(s) as inactive (211) and complete their circuit (212).

Although the invention has been explained in relation to its preferred embodiment, it is to be understood that many other possible modifications and variations can be made without departing from the spirit and scope of the invention.

1. A method for the logistical management of participant flow through a connected series of individual zones, the method comprising steps of:
Providing one or more groups of one or more participants;
Providing a server comprising
a microprocessor,
a server interface, and
non-transitory storage media;
Providing one or more participant interfaces;
Assigning a participant interface to each of the one or more groups of one or more participants;
Providing a network;
Providing a plurality of zones physically arranged in a circuit comprising
two or more starting zones,
two or more ventral zones,
one or more zonal hubs each comprising
a central access area, and
two or more spoke zones,
two or more retral zones, and
a terminal zone,
wherein
each zone comprises one or more sensors,
the two or more ventral zones are grouped in an ordered series of one or more ventral units corresponding to the number of starting zones,
the two or more starting zones are each connected to a corresponding ventral zone in a first ventral unit,
the two or more ventral zones of the one or more ventral units are each connected to the two or more ventral zones of the next subsequent ventral unit,
the two or more ventral zones of the last ventral unit are connected to the central access area of a first zonal hub and one or more spoke zones associated with that hub,
the two or more spoke zones of a zonal hub are connected to the zonal hub's central access area and up to two other spoke zones of the same zonal hub,
the one or more zonal hubs are connected to at least one other zonal hub through their corresponding central access areas when two or more zonal hubs are present,
the two or more retral zones are grouped in an ordered series of one or more retral units wherein each unit comprises the same number of retral zones,
one or more spoke zones of one or more zonal hubs is connected to the retral zones of the first retral unit,
the two or more retral zones of the one or more retral units are each connected to the two or more retral zones of the next subsequent retral unit, and
the two or more retral zones of the last retral unit are connected to the terminal zone;
Connecting the server, the one or more participant interfaces, and the one or more sensors of each zone through the network;
Providing a logistical application executed through the microprocessor of the server;
wherein the logistical application
Designates a participant group as active;
Tracks a position for each active group as the one or more sensors of each zone detect each group's arrival and departure from the zone;
Tracks the current usage of each zone;
Identifies each active group through its assigned participant interface;
Determines the number of zones through which each identified group will be guided;
Determines a series of zones and/or alternate zones through which each identified group may be guided by considering the number of zones through which an identified group will be guided and potential traffic from the active groups tracked through the logistical application;
wherein this series must:
begin at one of the one or more starting zones,
progress through one of the ventral zones of each ventral unit by order of the ventral units,
progress through one or more of the spoke zones at one or more zonal hubs,
progress through one of the retral zones of each retral unit by order of the retral units, and
progress through a terminal zone;
Assigns each identified group to a starting zone based upon availability determined through the logistical application's tracking of active groups;
Communicates the zone assignment by transmitting instructions from the logistical application through an identified group's participant interface;
Performs a sub-series of steps repeated for each zone visited by an identified group wherein the application
Logs each identified group's arrival at each zone into the logistical application as detected through the zone's one or more sensors;
Logs each identified group's departure from each zone into the logistical application as detected through the zone's one or more sensors;
Stores each logged times on the server's storage media;
Compares the time spent at the zone to each other active participant group from information stored in logs of the logistical application;
Generates a priority ranking for each identified group based on a comparison of logged times for each other active group;
Determine all available zones in the circuit;
Determine anticipated availability of all zones in the circuit;
Assigns each identified group to a subsequent zone in the series, using the priority ranking, available zones, and anticipated availability of zones to make the assignment; and
Communicates the updated zone assignment by transmitting a subsequent zone assignment for a group through its participant interface;
Designates an identified group as inactive once it departs from the terminal zone.

2. The method of claim 1, wherein the zones are holes of a golf course.

3. The method of claim 2, wherein connections between zones and zonal hubs or other zones comprise walking paths and cart paths.

4. The method of claim 2, wherein the golf course is a miniature golf course.

5. The method of claim 2, wherein the zones are arranged as two starting zones, a first ventral unit of two zones, a second ventral unit of two zones, a first zonal hub comprising six spoke zones, a second zonal hub comprising six spoke zones, a first retral unit comprising two zones, a second retral unit comprising two zones, and a terminal zone and wherein third and fifth spoke zones of the first zonal hub each connect to the two zones of the first retral unit, and wherein fourth and sixth spoke zones of the second zonal hub each connect to the two zones of the first retral unit.

6. The method of claim 5, further wherein a group must select nine or eighteen holes through which they will be guided.

7. The method of claim 6, wherein a nine hole selection progresses through a starting zone, then one ventral zone of each ventral unit, then three spoke zones of the first zonal hub ending with the third or fifth spoke zone, then one retral zone of each retral unit, and then the terminal zone.

8. The method of claim 6, wherein an eighteen hole selection progresses through a starting zone, then one ventral zone of each ventral unit, then six spoke zones of the first zonal hub, then six spoke zones of the second zonal hub ending with the fourth or sixth spoke zone, then one retral zone of each retral unit, and then the terminal zone.

9. The method of claim 5, wherein the two zones of one or more of the pairings of starting zones, ventral zones, or retral zones are each mirrored with the other zone of the unit pair.

10. The method of claim 5, wherein the two zones of one or more of the pairings of starting zones, ventral zones, or retral zones are each identical with the other zone of the unit pair.

11. The method of claim 1, wherein the participant interface is a graphical interface and is accessed through one or more electronic displays.

12. The method of claim 11, wherein each zone further comprises one of the one or more electronic displays through which the graphical interface is accessed.

13. The method of claim 11, wherein the one or more electronic displays are mobile computing devices.

14. The method of claim 1, wherein logged times are used to calculate an evolving expected time for each zone.

15. The method of claim 14, wherein the priority ranking incorporates the expected time for each zone into its ranking generation.

16. The method of claim 15, wherein the priority ranking is used to generate an estimated conclusion time for each participant group at its current zone.

17. The method of claim 16, wherein the estimated conclusion time of concurrently active groups is incorporated into determining assignments of subsequent zones.

18. The method of claim 16, wherein the priority rankings and estimated times of all concurrently active groups are used in conjunction with the expected times of each given zone to generate a predictive model for future positions of all concurrently active groups among the zones; storing the model on the server's storage media and allowing access through the server's interface.

19. The method of claim 1, wherein the zones are related exhibits at a museum.

20. A software system for the logistical management of participant flow through a connected series of individual zones, the system comprising:
A server comprising
a microprocessor,
a server interface, and
non-transitory storage media;
One or more participant interfaces comprising a graphical interface;
A network;
A logistical software application;
One or more zones comprising one or more sensors;
wherein
A first zone of the connected series of one or more zones is referred to as a starting zone;
A final zone of the connected series of one or more zones is referred to as a terminal zone;
The server, the one or more participant interfaces, and the one or more sensors of each zone are connected through the network by the software application;
The software application operates primarily through the microprocessor of the server;
wherein the application
Designates a participant group as active;
Tracks the position of each active group;
Tracks the current usage of each zone;
Identifies each active group through an assigned participant interface;
Determines the number of zones through which each identified group will be guided;
Determines a series of zones and/or alternate zones through which each identified group may be guided by considering the number of zones through which an identified group will be guided and potential traffic from the active groups tracked through the logistical application;
Assigns each identified group to a starting zone based upon availability determined through the logistical application's tracking of active groups;
Communicates the zone assignment by transmitting instructions from the logistical application through an identified group's participant interface;
Performs a sub-series of steps repeated for each zone visited by an identified group wherein the application:
Logs each identified group's arrival at each zone into the logistical application as detected through the zone's one or more sensors;
Logs each identified group's departure from each zone into the logistical application as detected through the zone's one or more sensors;
Stores each logged times on the server's storage media;
Compares the time spent at the zone to each other active participant group and historical time data of inactive participant groups from information stored in logs of the logistical application;
Generates a priority ranking for each identified group based on a comparison of logged times for each other active group;
Determine all available zones in the circuit;
Determine anticipated availability of all zones in the circuit;
Assigns each identified group to a subsequent zone in the series, using the priority ranking, available zones, and anticipated availability to make the assignment; and
Communicates the updated zone assignment by transmitting a subsequent zone assignment for a group through its participant interface;
Designates an identified group as inactive once it departs from the terminal zone.
